(19) United States
(12) Patent Application Publication
(10) Pub. No.: US 2009/0041337 A1
(43) Pub. Date: Feb. 12, 2009

(54) IMAGE PROCESSING APPARATUS AND METHOD

(75) Inventor: Tsuyoshi Nakano, Kanagawa (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/187,530

(22) Filed: Aug. 7, 2008

(30) Foreign Application Priority Data
Aug. 7, 2007 (JP) 2007-205182

(51) Int. Cl. G06K 9/00; H04N 7/18

(52) U.S. Cl. 382/154; 348/148; 348/E07.086

(57) ABSTRACT

Three-dimensional position information of each of feature points in a left and a right image is calculated based on a disparity between the left and right images; a lane marker existing on a road surface is detected from each of the left and right images; based on three-dimensional position information of a lane marker in a neighboring road surface area, by extending the lane marker to a distant area, a lateral direction position, and a depth direction position, of the extended lane marker in the distant area are estimated; an edge segment of a certain length or more is detected from feature points in the distant area in each of a plurality of images; three-dimensional position information of the edge segment is calculated; and, based on the three-dimensional position information of the edge segment, and on the extended lane marker information, a road incline in the distant area is estimated.

### CROSS-REFERENCE TO RELATED APPLICATION

This application is based upon and claims the benefit of priority from the prior Japanese Patent Application No. 2007-205182, filed on Aug. 7, 2007; the entire contents of which are incorporated herein by reference.

### FIELD OF THE INVENTION

The present invention relates to an image processing apparatus and method which, using an image acquired from a TV camera attached to a moving object typified by a vehicle such as an automobile, estimate an attitude of the vehicle or the like and a incline of a road on which it is traveling.

### DESCRIPTION OF THE INVENTION

To date, as a method of estimating an attitude of a vehicle or the like and an incline of a road, JP-A-2006-234682(Kokai) discloses a target object determination apparatus. JP-A-2006-234682(Kokai) calculates three-dimensional position information of feature points from an image acquired from a stereo camera. By projecting the feature points onto a lateral direction and depth direction plane using the three-dimensional position information of the feature points, the image is divided into a road area and the other area from a magnitude of a projection value. A short range road incline and a vehicle attitude are estimated from short range feature points belonging to a detected road area, and furthermore, by calculating a longitudinal curvature using long range distance information, the road incline is estimated.

Also, a method of a dynamic contour road model for a road tracking and a three-dimensional road shape restoration is disclosed in Yagi et al. “Dynamic Contour Road Model for Road Tracking and Three-dimensional Road Shape Restoration”, Journal of Institute of Electronics, Information and Communication Engineers D-II, Vol. J84-D-II, No. 8, pp. 1597-1607, 2001. According to the method by Yagi et al. a road area from an image acquired from a camera is detected and tracked. A reliable road border is detected using a road parallelism relationship as a constrained condition of the dynamic contour model, estimating the road incline.

However, in the case of estimating the road incline using only the three-dimensional position information of JP-A-2006-234682(Kokai), as an accuracy of long range three-dimensional position information degrades, it becomes difficult to distinguish between the road area and the other area. This has disadvantages of erroneously estimating a road shape using feature points of other than the road area.

Also, in the case of estimating the road incline using the road parallelism in Yagi et al., it is possible to estimate it in the event that two or more lane markers exist as on an expressway, but there is a problem of undetectability in the event that no plurality of lane markers exists, or the lane markers are not parallel.

Therein, the invention, in order to solve the heretofore described problems, has an object of providing an image processing apparatus and method which can estimate a road incline of a road surface, on which one's own vehicle is traveling, from a camera mounted on one's own vehicle.

### BRIEF SUMMARY OF THE INVENTION

According to one embodiment of the present invention, the embodiment is an image processing apparatus including an image acquisition unit configured to acquire a plurality of time-series image from two or more cameras which are mounted on an own vehicle and have a common visual field; a road surface area detection unit configured to detect a road surface area from the plurality of images, and to set a neighboring area, which is an area closer to the own vehicle than a preset distance, a neighboring road surface area, which is an area in which the road surface area overlaps the neighboring area, and a distant area, which is an area farther away than the neighboring area, in each of the plurality of images; a feature point detection unit configured to detect feature points from within each of the neighboring road surface area and distant area in each of the plurality of images; a three-dimensional information calculation unit configured to calculate, based on a disparity between the plurality of images, three-dimensional position information of each of the feature points in the plurality of images; a lane marker information acquisition unit configured to detect a lane marker existing on a road surface from each of the plurality of images, and to estimate, based on three-dimensional position information of the lane marker in the neighboring road surface area, by extending the lane marker to the distant area, a lateral direction and a depth direction position of the extended lane marker in the distant area; a distant area edge segment detection unit configured to detect an edge segment which is a collection of feature points having a certain length or more, from the feature points in the distant area in each of the plurality of images, and calculate three-dimensional position information of the edge segment; and a distant area road incline estimation unit configured to estimate, based on the three-dimensional position information of the edge segment, and on the extended lane marker information, a road incline in the distant area.

According to the embodiment of the invention, it is possible to estimate the road incline from the time-series images acquired from the two or more cameras mounted on one's own vehicle.

### BRIEF DESCRIPTION OF THE DRAWINGS

FIG. 1 is a block diagram of an image processing apparatus showing a configuration of one embodiment of the invention;

FIG. 2 is an illustration regarding a coordinate system in the embodiment;

FIG. 3 is an illustration regarding a borderline and a neighboring road surface area;

FIG. 4 is an illustration regarding a distant area;

FIG. 5 is an illustration regarding an edge detection filter;

FIG. 6 is an illustration of a method of detecting estimated lane markers;

FIG. 7 is a block diagram showing a vehicle attitude estimation unit;

FIG. 8 is an illustration of a left image and a right affine image;

FIG. 9 is an illustration regarding a correlation image;

FIG. 10 is an illustration regarding control points;

FIG. 11 is a block diagram showing a configuration of a road shape estimation unit;

FIG. 12 is an illustration regarding an edge segment tracking;

FIG. 13 is an illustration of a method of calculating a distance to an edge segment;

FIG. 14 is an illustration of a method of calculating a height of the edge segment;

FIG. 15 is an illustration regarding a discrepancy amount in the distant area; and

FIG. 16 is an illustration of a method of calculating a sequential line.

### DETAILED DESCRIPTION OF THE INVENTION

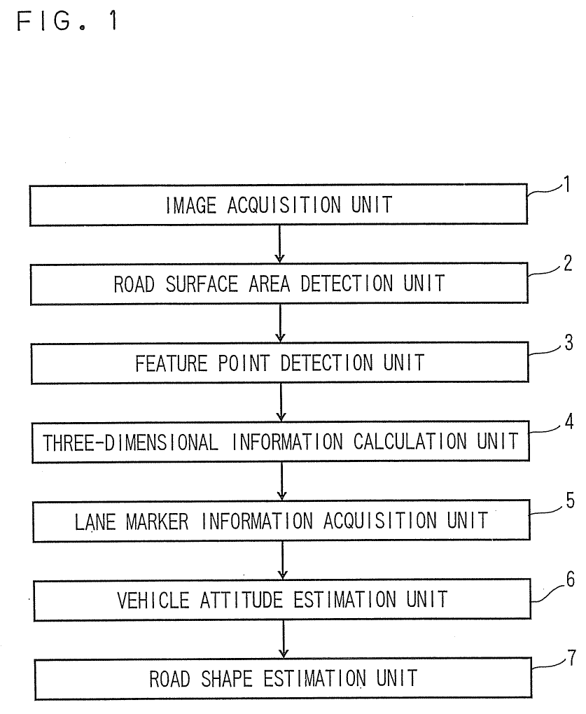

Hereafter, a description will be given, based on FIGS. 1 to 16, of an image processing apparatus of one embodiment of the invention.

FIG. 1 shows a configuration example of the image processing apparatus of the embodiment.

The image processing apparatus is configured of an image acquisition unit 1, a road surface area detection unit 2, a feature point detection unit 3, a three-dimensional information calculation unit 4, a lane marker information acquisition unit 5, a vehicle attitude estimation unit 6 and a road shape estimation unit 7.

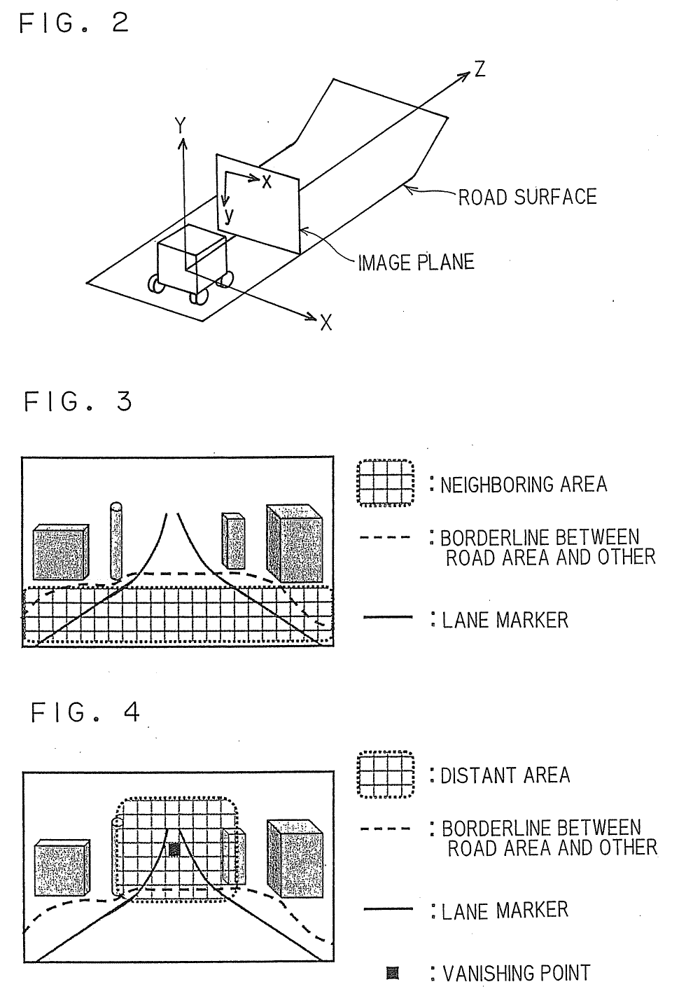

FIG. 2 shows a coordinate system in the embodiment. As shown in FIG. 2, in a real space in which one's own vehicle travels, a lateral direction is taken as X, a height direction as Y, and a depth direction as Z, and a horizontal direction of an image coordinate system is taken as x, and a vertical direction as y.

Functions of these individual units 1 to 7 are actualized by means of a program stored in a computer readable medium. Hereafter, a description will be given of the functions of the individual units 1 to 7 in order.

The image acquisition unit 1 being formed of two TV cameras, attached to one's own vehicle which moves, which acquire a time-series image of a surrounding, particularly what lies ahead, of the vehicle, the cameras have a common visual field by means of a stereo vision.

Firstly, the road surface area detection unit 2 sets an area proximate to one's own vehicle, for example, an area within 30 m from one's own vehicle, as a neighboring area. Herein, as a distance from one's own vehicle, Z value information obtained by the three-dimensional information calculation unit 4, to be described hereafter, is used.

Next, as shown in FIG. 3, the road surface area detection unit 2 detects in the neighboring area a borderline between a road surface area and the other area. An area on one's own vehicle side from the borderline detected is taken as the road surface area.

As a method of detecting the borderline between the road surface area and the other area, there is a method according to JP-A-2006-53890 (Kokai). Methods of distinguishing between the road surface area and the other area, used in the embodiment, also being proposed variously, it is acceptable to use any method.

Next, the road surface area detection unit 2 sets an area, in which the neighboring area overlaps the road surface area, as a neighboring road surface area. The neighboring road surface area not necessarily being accurately obtained, it is sufficient to know its rough position.

Firstly, as shown in FIG. 4, the feature point detection unit 3 sets an optional size of an area, which is farther away than the neighboring area and near a center of the image, that is, near a vanishing point, as a distant area.

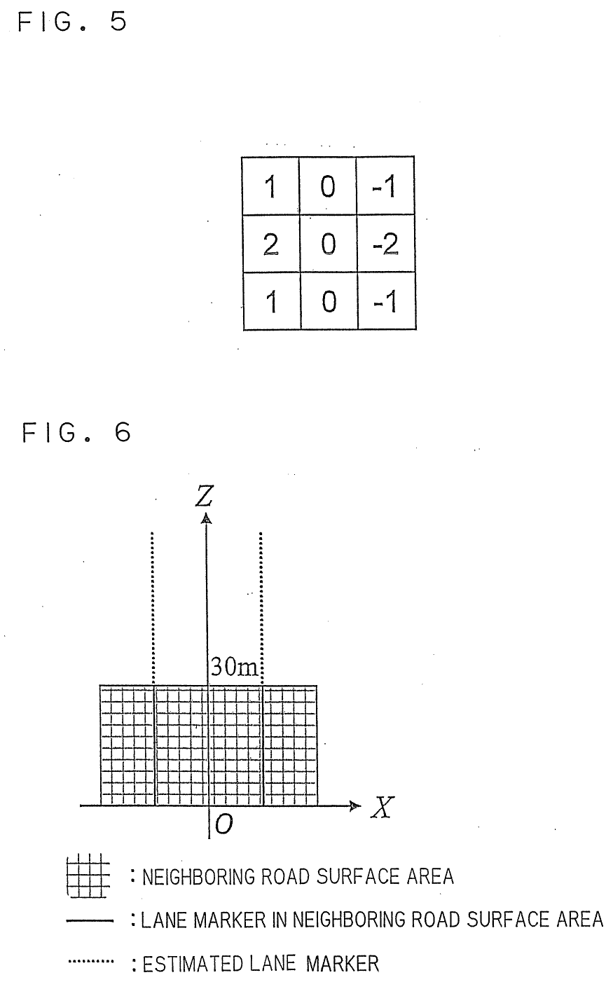

Next, the feature point detection unit 3, using the kind of longitudinal Sobel filter shown in FIG. 5, detects edge images in the neighboring road surface area and distant area detected by the road surface area detection unit 2. With regard to the edge detection, it is also acceptable to use not only the Sobel filter, but any filter.

Next, the feature point detection unit 3, by carrying out a thinning process, divides an edge with an edge strength of a threshold value or greater into segments. Individual points configuring the thinned edge segments are taken as feature points.

The three-dimensional information calculation unit 4, using a principle of triangulation, measures each of three-dimensional positions of the individual feature points obtained above from two or more cameras placed in different positions.

In the embodiment, the two TV cameras, a left camera and a right camera, are installed so as to measure the three-dimensional position of each feature point. The two cameras are taken to be calibrated in advance, or to be of a parallel stereo.

When supposing that a point (X, Y, Z) on an object is projected onto a position (xₗ, yₗ) on an image of the left camera, a corresponding point (xᵣ, yᵣ) on an image of the right camera is searched for.

The search for the corresponding point is carried out using an evaluation value of the kind of sum of absolute differences shown in Equation (1). A target image of which a size is MXN is taken as I (m, n), and a template as T (m, n). The evaluation value not being limited to being of the sum of absolute differences, it is also acceptable to use another evaluation value.

$$SAD = {\sum }_{j = n}^{N} {\sum }_{i = m}^{M} \vert \{ I ( i , j ) - \overline{I} \} - \{ T ( i , j ) - \overline{T} \} \vert \\ \overline{I} = {\sum }_{j = n}^{N} {\sum }_{i = m}^{M} I ( i , j ) / MN \\ \overline{T} = {\sum }_{j = n}^{N} {\sum }_{i = m}^{M} T ( i , j ) / MN \qquad ( 1 )$$

A disparity d is obtained from the corresponding point, and the three-dimensional position of each feature point is calculated using Equation (2). b is taken as a camera interval, and f as a focal distance.

$$[ \begin{matrix}X \\ Y \\ Z\end{matrix} ] = \frac{b}{d} [ \begin{matrix}{x}_{l} \\ {y}_{l} \\ f\end{matrix} ] \\ d = {x}_{l} - {x}_{r} \qquad ( 2 )$$

Herein, in the road surface area in the image, the disparity d is taken to change only with respect to a longitudinal direction y of the image, and not to change with respect to a lateral direction x.

Firstly, the lane marker information acquisition unit detects a lane marker, which is a borderline of a lane on which one's own vehicle is currently traveling, from a road surface detected by the road surface area detection unit 2.

As a lane marker detection method, various methods, such as a method according to JP-A-7-89367 (Kokai), having been proposed, it is also acceptable to use any method.

Next, the lane marker information acquisition unit 5 calculates three-dimensional positions for all the points on the lane marker which have been obtained by doing the same as in the method in the three-dimensional information calculation unit 4.

As shown in FIG. 6, the points are projected onto an XZ plane using X and Z values in the three-dimensional positions calculated. In the XZ plane (a plane seen from above), a curvature of lane markers in the neighboring road surface area is calculated, the lane markers are extended to the distant area, and the lane markers extended are taken as estimated lane markers.

Also, a number of lane markers not necessarily being two, it is also acceptable that it is one or a plural number.

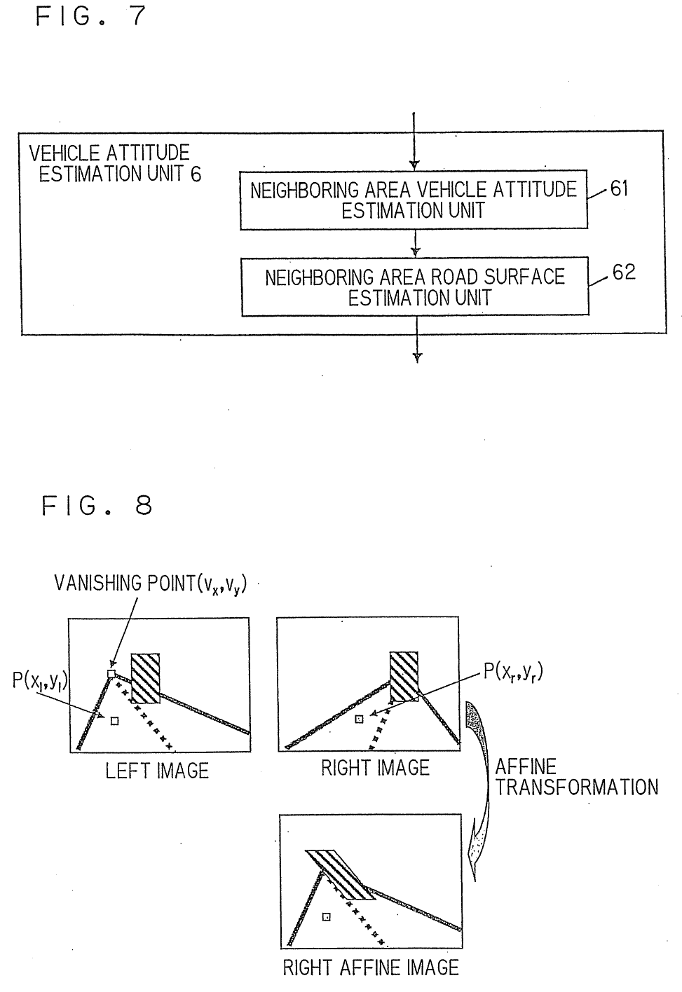

As shown in FIG. 7, the vehicle attitude estimation unit 6 is configured of a neighboring area vehicle attitude estimation unit 61 and a neighboring area road surface estimation unit 62.

A description will be given of a function of the neighboring area vehicle attitude estimation unit 61.

A left image and a right image, obtained from the left and right cameras, are taken to be subjected in advance to a rectification which carries out an alignment with respect to the longitudinal direction y of the image. On taking coordinates of the vanishing point as (vₓ, v_{y}), a position of a point P on the road surface, in the left image, as (xₗ, yₗ), and a position thereof in the right image as (xᵣ, yᵣ) , as shown in FIG. 8, both positions are correlated by means of the kind of affine transformation in Equation (3).

$$( \begin{matrix}{x}_{l} \\ {y}_{l}\end{matrix} ) = ( \begin{matrix}1 & {b}^{′} \\ 0 & 1\end{matrix} ) ( \begin{matrix}{x}_{r} \\ {y}_{r}\end{matrix} ) + ( \begin{matrix}- {b}^{′} {v}_{y} \\ 0\end{matrix} ) \qquad ( 3 )$$

That is, the left image obtained from the left camera, and a right affine image, into which the right image obtained from the right camera is affinely transformed, come to have the same pattern position on the road surface. Parameters of the affine transformation at this time are obtained in advance by means of the calibration. Also, a disparity d₀ (y) in the road surface is also obtained in advance from this correlation relationship.

However, on the vehicle actually traveling on the road, a relative positional relationship between the road surface and the cameras varies due to a vibration or the like of a vehicle body. For this reason, even when rendering the transformation with the parameters obtained in advance, a discrepancy may occur between the left and right road surface patterns. As the rectification has been done, the discrepancy occurs in a horizontal direction. This is because, even when a vertical vibration occurs in the vehicle, as both cameras vibrate vertically in the same way, the discrepancy occurs only in the horizontal direction. Then, a principal factor of the discrepancy is a change in a vehicle attitude due to a vertical motion, or a pitching, of the vehicle, in which case a discrepancy amount e (y) is expressed by the kind of primary expression in Equation (4) relating to y coordinates of the images.

e(y)=βy+γ (4)

As shown in the left diagram of FIG. 9, taking a feature point in the left image as a reference for each horizontal line, a correlation value between the left image and the right affine image is obtained for w pixels in a left and right direction in the right affine image. The correlation value is taken as a value of whichever is smaller, an edge strength in the left image or an edge strength in the right affine image. To describe it in more detail in FIG. 9, taking the edge strength in the left image as S1, and the edge strength in the right affine image as S2, in the event that S1<S2, S1 is reflected in the right diagram of FIG. 9 as the correlation value while, in the event that S1>S2, S2 is reflected in the right diagram of FIG. 9 as the correlation value. Evaluation formulas calculating a correlation being proposed variously, it is also acceptable to use another evaluation formula for a difference or the like.

This process is scanned in the horizontal direction, and the correlation at each feature point is added to a correlation image. Then, the same process is carried out in all the horizontal lines, generating the correlation image in the right diagram of FIG. 9. This process is carried out only in the neighboring road surface area.

A straight line is obtained using Hough transformation with respect to the correlation image in the right diagram of FIG. 9. β and γ in Equation (4) are calculated. β and γ relate to a height, and a pitch angle, from the road surface of the cameras mounted on the vehicle.

Then, the road surface positions in the left image and the right affine image are correlated in accordance with β and γ obtained and the kind of affine transformation formula in Equation (5).

$$( \begin{matrix}{x}_{l} \\ {y}_{l}\end{matrix} ) = ( \begin{matrix}1 & {b}^{′} + β \\ 0 & 1\end{matrix} ) ( \begin{matrix}{x}_{r} \\ {y}_{r}\end{matrix} ) + ( \begin{matrix}- {b}^{′} {v}_{y} + γ \\ 0\end{matrix} ) \qquad ( 5 )$$

The disparity d in the road surface is obtained from this correlation relationship. That is, xₗ and xᵣ are obtained from Equation (5), and the disparity d=xₗ−xᵣ is calculated. As heretofore described, in the road surface area in the image, the disparity d changes with respect only to the longitudinal direction y of the image, and does not change with respect to the lateral direction x.

A description will be given of a function of the neighboring area road surface estimation unit 62.

In an actual road environment, the road is not always planar. It is necessary to detect a parameter taking the road surface not to be planar, but to be curved (that is, the road has an incline). For this reason, the following process is carried out in order to correct the straight line in Equation (4), in which β and γ have been obtained supposing the road surface to be planar, to three sequential lines corresponding to the incline of the road.

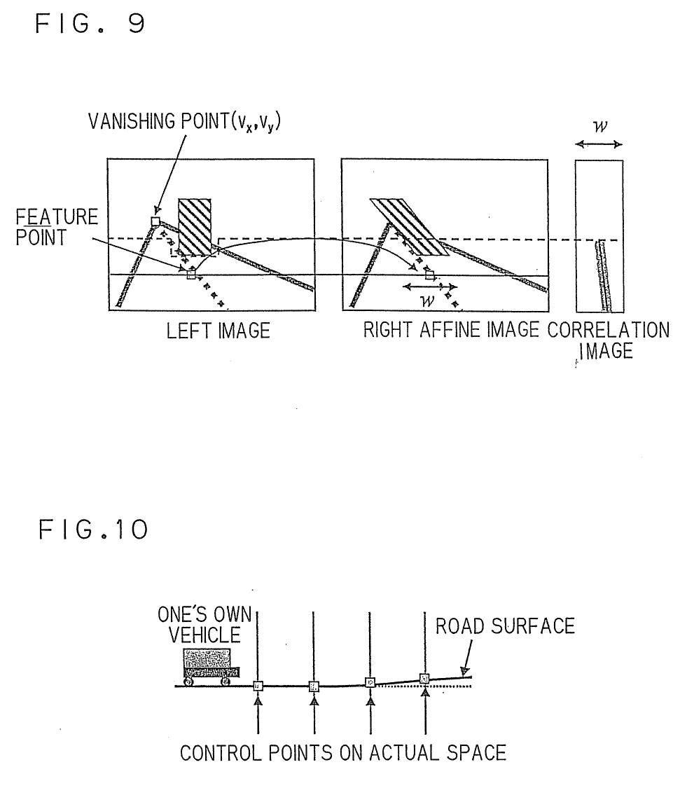

Firstly, as shown in FIG. 10, four setting points are set at predetermined intervals in the Z axis direction of actual space coordinates in the neighboring road surface area. For example, they are set 10 m, 15 m, 20 m and 25 m respectively apart from the position of the vehicle. The setting points are determined from a field angle or the like of the cameras.

Next, the disparities d with respect to the four setting points are obtained.

Next, control points at which the four setting points are transformed into positions in the image are calculated from the setting points and the disparities d.

Next, from the four control points, Equation (4) is re-expressed by the three sequential lines. That is, β and γ are recalculated for each sequential line.

Next, by moving the control points in the x direction and the z direction using a dynamic programming method, in the correlation image of FIG. 9, the three sequential lines are refitted in such a way that a sum of the correlation values in sequential line passing positions reaches a maximum, obtaining four final control points.

Next, β and γ corresponding to each of the four final control points are obtained, and furthermore, the disparities d are obtained. The disparities d represent more accurate disparities in the neighboring road surface area. Equation (5) is used to obtain the disparities d from β and γ.

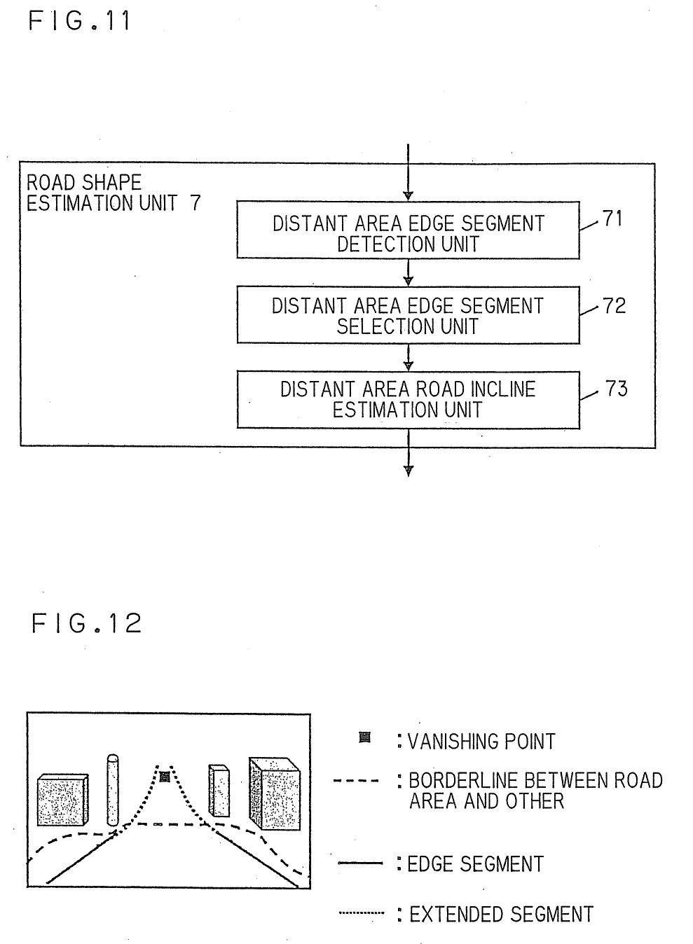

As shown in FIG. 11, the road shape estimation unit 7 is configured of a distant area edge segment detection unit 71, a distant area edge segment selection unit 72 and a distant area road incline estimation unit 73.

In the actual road environment, there is a case in which the road incline changes abruptly. For this reason, the road shape estimation unit 7 firstly estimates a road incline of the distant area, and after that, connects it to the road incline in the neighboring road area which has been obtained above.

A description will be given of a function of the distant area edge segment detection unit 71.

The distant area edge segment detection unit 71 pays attention to the feature points in the neighboring road surface area and the distant area which have been detected by the feature point detection unit 3.

Firstly, a cluster, that is, a collection of connected feature points, as typified by the lane marker in the neighboring road surface area, which faces in a vanishing point direction, and has a length of a certain threshold value or greater, is detected as an edge segment. A threshold value at this time is determined from the angle field or the like of the cameras. The lane marker estimated by the lane marker information acquisition unit 5 is also included in the edge segment.

Next, as shown in FIG. 12, the detected edge segments are tracked by checking whether the feature points are connected to the distant area side straddling the borderline. By means of this process, the edge segments are extended to the distant area side.

Next, the points are projected onto the XZ plane using the X and Z values in the three-dimensional position information which, relating to the extended edge segments, have been calculated by the three-dimensional information calculation unit 4.

A description will be given of a function of the distant area edge segment selection unit 72.

What exists on other than the road surface is also included in the edge segments detected by the distant area edge segment detection unit 71. Only what exists only on the road surface is selected using the three-dimensional position information of the edge segments, and the lane marker information. A specific description will be given hereafter.

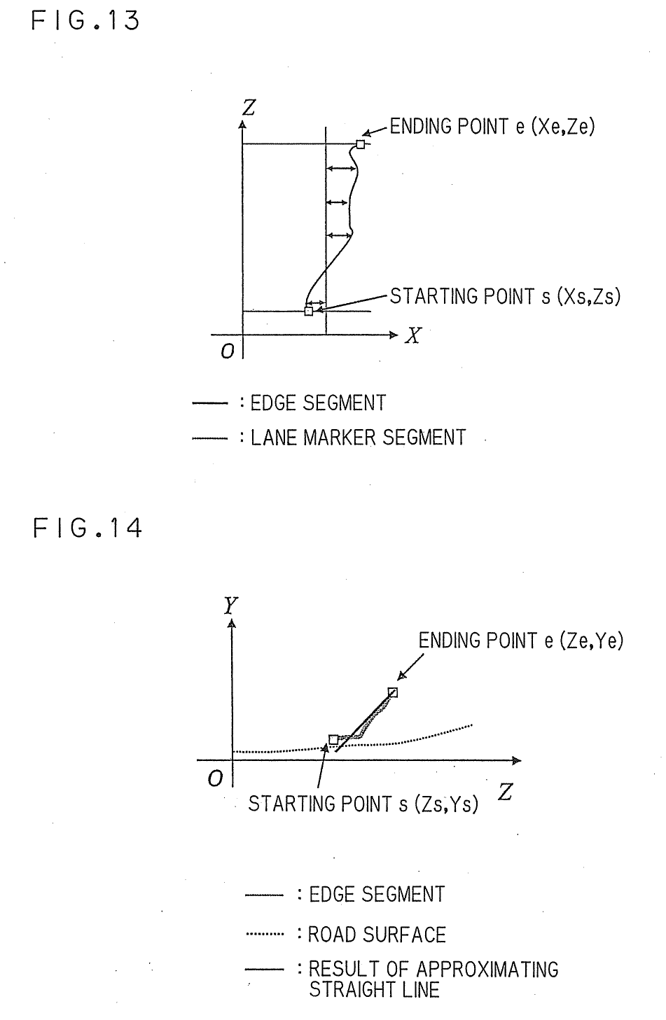

Firstly, on the XZ plane, the lane marker estimated by the lane marker information acquisition unit 5 is taken as a lane marker segment. With regard to the lane marker segment and the edge segment, as shown in FIG. 13, a mean value Xm, and a variance value Xv, of X direction distance absolute differences of individual points between a starting point s, and an ending point e, of the edge segment are obtained. Herein, the X direction distance absolute differences are absolute values of differences between a position of the lane marker segment, and a position of the edge segment, in the X direction.

Next, as shown in FIG. 14, a difference Hd (=H1−H2), between a mean value Hi of heights between the starting point s and ending point e of the edge segment, and a mean value H2 of heights of the road surface at individual points within a distance between Zs and Ze in which the edge segment exists (a mean value of heights of the road surface which are indicated by the dotted line of FIG. 14), is obtained.

Next, a relationship of the edge segment with Y and Z is calculated by a least squares method as Equation (6), obtaining an inclination a at this time.

Y=aZ+b (6)

A case in which the X direction distance mean value Xm is smaller than a certain threshold value is taken as a first condition. A case in which the X direction distance variance value Xv is smaller than a certain threshold value is taken as a second condition. A case in which the height difference Hd is smaller than a certain threshold value is taken as a third condition. A case in which an absolute value of the inclination a is smaller than a certain threshold value is taken as a fourth condition. Then, an edge segment fulfilling all the four conditions is selected, and taken as a “road surface segment”. These thresholds are appropriately determined from the angle field or the like of the cameras.

A description will be given of a function of the distant area road incline estimation unit 73.

Firstly, an edge point disparity in the road surface segment selected by the distant area edge segment selection unit 72 is obtained.

Next, the road surface disparity d₀ (y) obtained in advance by means of the calibration is retrieved.

Next, a difference between this road surface disparity d₀ (y) and the heretofore described edge point disparity in the road surface segment is obtained as a discrepancy amount E (y).

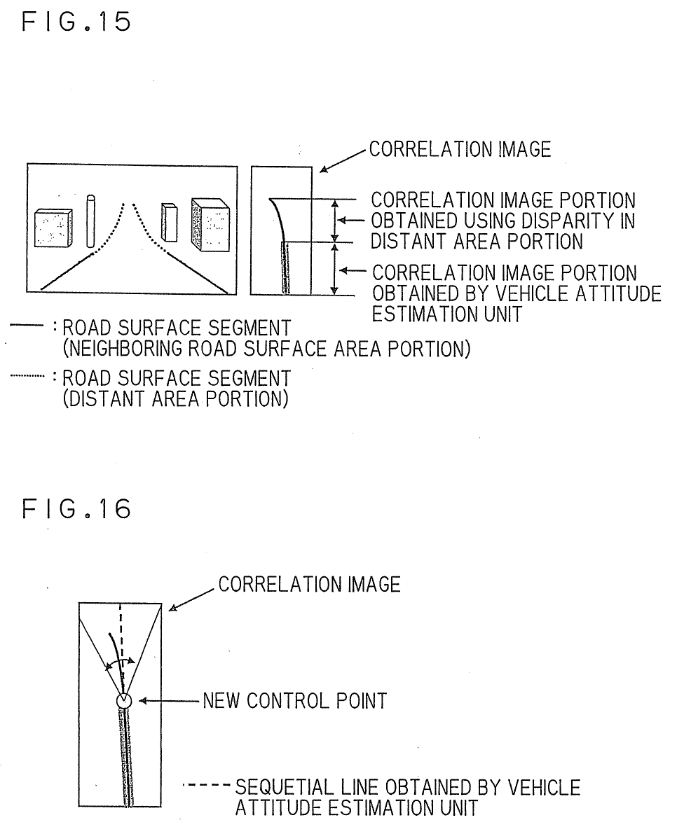

Next, the discrepancy amount E (y) is fitted into the kind of correlation image shown in the right diagram of FIG. 15. That is, a horizontal direction position in the correlation image is taken as the discrepancy amount E, and also, a y coordinate value of a position of the edge point in the image is taken as a vertical direction position in the correlation image. Then, in the correlation image, an edge point strength value in the road surface segment is added to the obtained positions. By this means, a curved line using the disparities in the distant area is completed.

The correlation image portion obtained by the neighboring area road surface estimation unit 62, that is, the correlation image shown in the right diagram of FIG. 9, is expressed in a bottom portion of the correlation image in the right diagram of FIG. 15. Also, the three sequential lines obtained by the neighboring area road surface estimation unit 62 are expressed in the bottom portion of the correlation image.

Next, on the basis of the three sequential lines obtained by the neighboring area road surface estimation unit 62, a new control point is added in order to generate one more sequential line. In this addition method, as shown in FIG. 16, the new control point is scanned on the sequential line, various segments having various inclinations are tentatively determined from the new control point, and a new control point position and an inclination are obtained in which a sum of correlation values of positions through which the sequential line passes reaches a maximum, carrying out a refitting. That is, a new control point is obtained which enables the three sequential lines obtained by the neighboring area road surface estimation unit 62, and the curved line using the disparity in the distant area, to be connected by one line. Then, β and γ expressed by Equation (4) are obtained, and the disparity d is obtained from Equation (5).

Then, from a result of the fitting, in the case also in which the road surface incline changes abruptly, a more accurate disparity in the road surface being obtained, it is possible to estimate an incline of a whole of the road. That is, in the event that the road is planar (for example, horizontal) from a neighboring position to a distance, there being no difference between a disparity with respect to an edge segment from the obtained neighboring position to the distance, and the road surface disparity d₀ (y) obtained in advance by means of the calibration, the line in the correlation image of FIG. 16 extends straight in the center, but when there is an incline, a difference occurring between the disparities, the line is curved.

The following is carried out in order to obtain an incline 0 of the road from the obtained disparity d.

Firstly, the disparity d and two positions of the road surface in the image are assigned to Equation (2), obtaining a height Y1 and a depth Z1, and a height Y2 and a depth Z2, of the road at two points.

Next, the incline θ is obtained from (Y1−Y2) and (Z1−Z2) That is, tan θ=(Y1−Y2)/(Z1−Z2) is obtained.

In the image processing apparatus of the embodiment, the heretofore described kind of process being carried out on the time-series image, it is possible to estimate an accurate, vehicle attitude, and incline of a road ahead of one's own vehicle.

The invention, not being limited to each heretofore described embodiment, can be modified variously without departing from the scope thereof.

What is claimed is:

1. An image processing apparatus comprising:
an image acquisition unit configured to acquire a plurality of time-series images from two or more cameras which are mounted on an own vehicle and have a common visual field;
a road surface area detection unit configured to detect a road surface area from the plurality of images, and to set a neighboring area, which is an area closer to the own vehicle than a preset distance, a neighboring road surface area, which is an area in which the road surface area overlaps the neighboring area, and a distant area, which is an area farther away than the neighboring area, in each of the plurality of images;
a feature point detection unit configured to detect feature points from within each of the neighboring road surface area and distant area in each of the plurality of images;
a three-dimensional information calculation unit configured to calculate, based on a disparity between the plurality of images, three-dimensional position information of each of the feature points in the plurality of images;
a lane marker information acquisition unit configured to detect a lane marker existing on a road surface from each of the plurality of images, and to estimate, based on three-dimensional position information of the lane marker in the neighboring road surface area, by extending the lane marker to the distant area, a lateral direction and a depth direction position of the extended lane marker in the distant area;
a distant area edge segment detection unit configured to detect an edge segment which is a collection of feature points having a certain length or more, from the feature points in the distant area in each of the plurality of images, and calculate three-dimensional position information of the edge segment; and
a distant area road incline estimation unit configured to estimate, based on the three-dimensional position information of the edge segment, and on the extended lane marker information, a road incline in the distant area.

2. The apparatus according to claim 1, wherein
the distant area edge segment detection unit detects in the distant area the edge segment facing in a vanishing point direction in the image, and calculates the three-dimensional position information of the edge segment, and
the distant area road incline estimation unit, using a positional relationship between the three-dimensional position information of the edge segment and the extended lane marker information, selects an edge segment existing on the road surface in the distant area, and estimates a road incline in the distant area from three-dimensional information of the selected edge segment.

3. The apparatus according to claim 2, wherein
the distant area edge segment detection unit determines whether or not feature points of an edge segment, existing in a vicinity of a borderline between the neighboring road surface area and the distant area, and in the neighboring road surface area, which has the certain length or more, are connected to the distant area, and extends the edge segment, the feature points of which are determined to be thus connected, in the vanishing point direction, calculating three-dimensional position information of the extended edge segment.

4. The apparatus according to claim 2, wherein
the distant area road incline estimation unit, when taking the lateral direction of the road surface as X, and the depth direction as Z, in an XZ plane, selects an edge segment which fulfills at least one of a first condition of a distance between the extended lane marker and the edge segment being a threshold value or smaller, a second condition of the extended lane marker being parallel to the edge segment, and a third condition of a height of the edge segment changing smoothly based on the three-dimensional position information of the edge segment.

5. The apparatus according to claim 1, further comprising a neighboring area road surface estimation unit configured to obtain a road incline of the road surface existing in the neighboring road surface area; and wherein the distant area road incline estimation unit connects the road incline in the neighboring road surface area and the road incline in the distant area, and estimate a whole road incline from the neighboring area to the distant area.

6. The apparatus according to claim 5, wherein
the neighboring area road surface estimation unit calculates an amount of discrepancy between image information of an optional position of the neighboring road surface area in one image, among the plurality of images, and image information corresponding to the optional position when another image, among the plurality of images, is affinely transformed into the one image, in a longitudinal direction of the image, obtaining an incline of the road surface in the neighboring area from the discrepancy amount.

7. The apparatus according to claim 5, wherein
the distant area road incline estimation unit connects a straight line representing the incline of the road surface in the neighboring area and a curved line representing the road incline in the distant area, obtaining the whole road incline.

8. An image processing method comprising:
acquiring a plurality of time-series images from two or more cameras which are mounted on an own vehicle and have a common visual field;
detecting a road surface area from the plurality of images, and setting a neighboring area, which is an area closer to the own vehicle than a preset distance, a neighboring road surface area, which is an area in which the road surface area overlaps the neighboring area, and a distant area, which is an area farther away than the neighboring area, in each of the plurality of images;
detecting feature points from within each of the neighboring road surface area and distant area in each of the plurality of images;
calculating, based on a disparity between the plurality of images, three-dimensional position information of each of the feature points in the plurality of images;
detecting a lane marker existing on a road surface from each of the plurality of images, and estimating, based on three-dimensional position information of the lane marker in the neighboring road surface area, by extending the lane marker to the distant area, a lateral direction and a depth direction position of the extended lane marker in the distant area;
detecting an edge segment which is a collection of feature points having a certain length or more, from the feature points in the distant area in each of the plurality of images, and calculating three-dimensional position information of the edge segment; and
estimating, based on the three-dimensional position information of the edge segment, and on the extended lane marker information, a road incline in the distant area.

9. A program product stored in a computer readable medium, comprising instructions of:
acquiring a plurality of time-series images from two or more cameras which are mounted on an own vehicle and have a common visual field;
detecting a road surface area from the plurality of images, and setting a neighboring area, which is an area closer to the own vehicle than a preset distance, a neighboring road surface area, which is an area in which the road surface area overlaps the neighboring area, and a distant area, which is an area farther away than the neighboring area, in each of the plurality of images;
detecting feature points from within each of the neighboring road surface area and distant area in each of the plurality of images;
calculating, based on a disparity between the plurality of images, three-dimensional position information of each of the feature points in the plurality of images;
detecting a lane marker existing on a road surface from each of the plurality of images, and estimating, based on three-dimensional position information of the lane marker in the neighboring road surface area, by extending the lane marker to the distant area, a lateral direction, and a depth direction position, of the extended lane marker in the distant area;
detecting an edge segment which is a collection of feature points having a certain length or more, from the feature points in the distant area in each of the plurality of images, and calculating three-dimensional position information of the edge segment; and
estimating, based on three-dimensional position information of the edge segment, and on extended lane marker information, a road incline in the distant area.
